(19) United States
(12) Patent Application Publication
(10) Pub. No.: US 2010/0299614 A1
(43) Pub. Date: Nov. 25, 2010

(54) User Interface of a Mobile Device Having a Toolbar for Composing Rich Text Messages

(75) Inventors: Paul Wayne Hangas, San Jose, CA (US); Xin Hu, San Jose, CA (US); Heather Marie LeRoy, Saratoga, CA (US)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/469,528

(22) Filed: May 20, 2009

(51) Int. Cl. G06F 3/01; G06F 3/048

(52) U.S. Cl. 715/752; 715/784

(57) ABSTRACT

A communication device for communicating electronic messages with a remote device is described. The device comprises a transmitter, a user interface, a processor, and a display. The transmitter sends an electronic message to the remote device, in which the electronic message comprises a message header indicating a recipient's address and a message body including textual content. The user interface generates input signals based on interaction with a user of the communication device. The processor creates the electronic message based on the input signals and provides the electronic message to the transmitter. The display provides an attribute selectable toolbar positioned between the message header and the message body. The attribute selectable toolbar provides a plurality of attributes that are capable of being applied to the textual content of the message body. For certain embodiments, an attribute indicator may be provided to represent all attributes selected by the user interface.

### FIELD OF THE INVENTION

The present invention relates generally to the field of communication devices for communicating electronic messages. More particularly, the present invention relates to communication devices that facilitate a user's ability to create enhanced text messages by making such features readily available.

### BACKGROUND OF THE INVENTION

Client applications of communication devices allow users to send communication messages to one another in rich-text format. The recipient of the communication messages needs to use a messaging system that displays rich-text formatting in order to view the rich-text attributes of the rich-text format. Messaging systems that do not support rich-text formatting will display the communication messages as plain text without the attributes or formatting. Rich-text attributes of the rich-text format include font name, font size, font style (such as regular, italic, bold and/or underline), font color, and font effects (such as strikethrough or bullet lists).

Although messaging systems for desktop and laptop computers allow a user to compose messages in rich-text format, mobile devices are not as capable with providing this ability. In particular, the small real estate of the display of a mobile device must be used efficiently when providing this rich-text format.

Communication devices may use a toolbar to provide features so that they are readily available to users of the devices, but existing toolbars do not provide rich-text formatting capabilities due to the limited space of the display. In particular, existing toolbars do not provide rich-text formatting capabilities and are not situated so that the rich-text attributes are readily available and associated with the applicable text.

### BRIEF DESCRIPTION OF THE DRAWINGS

FIG. 1 is a perspective view of an embodiment in accordance with the present invention.

FIG. 2 is a block diagram of example components of the embodiment of FIG. 1.

FIGS. 3 through 5 are screen views illustrating example views that may be shown on a display of the embodiment of FIG. 1.

FIG. 6 is a flow diagram of an example operation of the embodiment of FIG. 1.

### DETAILED DESCRIPTION OF THE EMBODIMENTS

There is described a communication device, and method thereof, to facilitate the use of rich-text capability, i.e., rich-text attributes of a rich-text format, for creating electronic messages. The device and method provides rich-text attributes on a persistent, selectable toolbar that is positioned adjacent to the text area associated with the attributes.

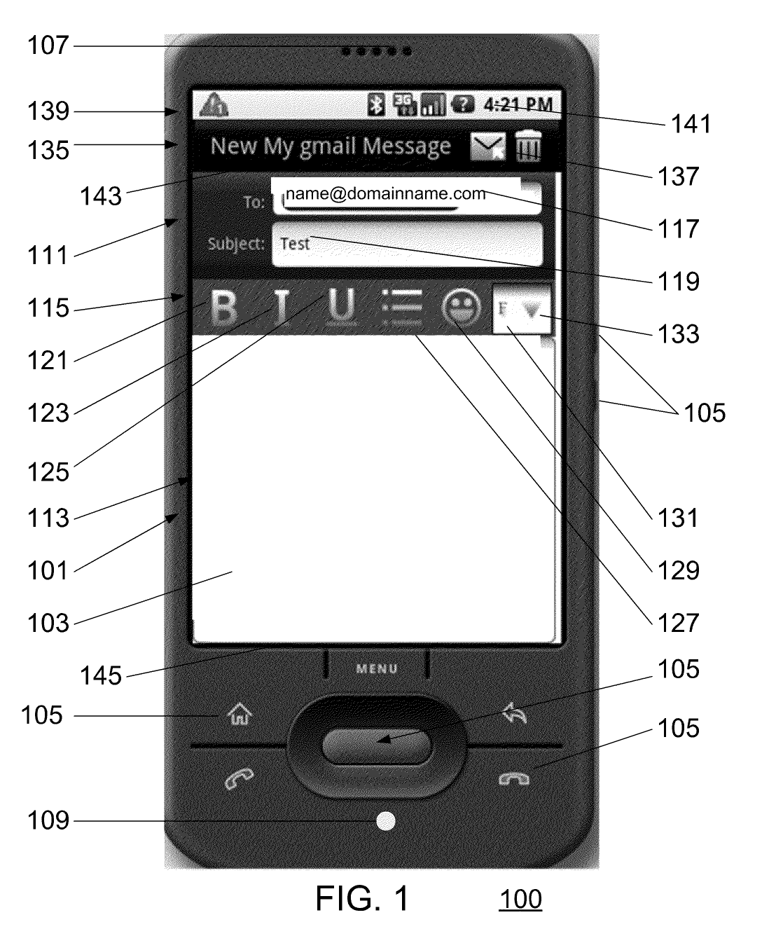

Referring to FIG. 1, there is illustrated a perspective view of an embodiment in accordance with the present invention. The embodiment may be any type of communication device 100 having the capability of transmitting electronic messages to another device. Examples of the communication device 100 include, but are not limited to, cellular-based mobile phones, WLAN-based mobile phones, notebook or laptop computing devices, personal digital assistants, personal navigation device, touch screen input device, pen-based input devices, portable video and/or audio players, and the like.

For one embodiment, the communication device 100 has a housing comprising a surface which includes a visible display 101 and a user interface. For example, the user interface may be the touch-sensitive surface 103 of the display 101. For another embodiment, the user interface of the communication device 100 may include one or more input keys 105 used in conjunction with, or instead of, the touch-sensitive surface 103. Examples of the input key or keys 105 include, but are not limited to, keys of an alpha or numeric keypad, a physical keys, touch-sensitive surfaces, multipoint directional keys. For yet another embodiment, the communication device 100 may comprise apertures 107, 109 for audio output and input at the surface. It is to be understood that the communication device 100 may include a variety of different combination of displays and interfaces.

The communication device 100 may operate in different operational modes throughout its use by a user. One of these operational modes may be a messaging mode for communicating electronic messages to other devices, including the opportunity to create electronic messages or edit existing messages. For the messaging mode, the display 101 of the communication device 100 may be partitioned into a plurality of regions for providing specific functionality in each region. For one embodiment, the display 101 may include a message header 111, a message body 113 and a rich-text selectable toolbar 115. The message header may provide information about an electronic message that facilitates transport of the message to a particular destination and its recipient. For example, the message header may indicate the destination address 117 for the electronic message. As illustrated in FIG. 1, the destination address may include a domain name associated with a server and a user name associated with an entity served by the server. The message header may also provide summary information 119 about the contents of message body 113. The message body may include textual information, such as alphanumeric text or symbols, and/or image information, such as media or multimedia.

Depending upon the embodiment, the rich-text selectable toolbar 115 may or may not be positioned adjacent to the message header. For example, for the embodiment shown in FIG. 1, the rich-text selectable toolbar 115 is positioned between, and adjacent to, the message header 111 and the message body 113. The rich-text selectable toolbar 115 provides one or more rich-text attributes applicable to the textual content of the message body 113. The rich-text selectable toolbar 115 may take the form of a variety of different configurations, such as the linear configuration represented in FIG. 1 or non-linear configuration as may fit within the boundaries. Each attribute of the rich-text selectable toolbar 115 is selectable by the user interface. The rich-text attributes may include, but are not limited to, a font name, font size, font style, font color, or font effects. For example, as illustrated in FIG. 1, the rich-text selectable toolbar 115 may include font styles, such as bold 121, italics 123 and underline 125. Other examples of rich-text attributes that may be included in the rich-text selectable toolbar 115 include bullets 127, symbols 129 such as emoticons, an attribute indicator 131 representing a visual representation of the rich-text attributes selected via the user interface, and a dropdown menu 133 for selecting additional rich-text attributes. Each attribute is capable of being selected via the user interface, and all attributes selected by the user interface are represented by the attribute indicator 131. For example, if the bold style 121, italics style 123 and underline style 125 are selected via the user interface, then the attribute indicator 131 will be shown in bold, italics and underline to indicate to the user that these attributes will be applied to subsequent or selected text.

In addition to the message header 111, the message body 113, and the rich-text selectable toolbar 115, the display 101 of the communication device 100 may include other regions that may be useful to a user of the device. For example, the display 101 may provide a messaging toolbar 135 for indicating message status and/or providing message handling features 137. As another example, the display 101 may provides a device toolbar 139 for indicating device status and/or general information 141.

For the messaging mode, the display 101 of the communication device 100 may further provide boundaries 143, 145 within which content is provided. The rich-text selectable toolbar 115, in its entirety, is always provided within the boundaries in the messaging mode regardless of the position of the message header 111 and the message body 113. In particular, the display 101 includes an upper boundary 143 and a lower boundary 145 opposite the upper boundary, and the longer sides of the rich-text selectable toolbar are parallel to the upper and lower boundaries. For this embodiment, the rich-text selectable toolbar 115 may not be positioned beyond the upper boundary or the lower boundary in the messaging mode. It should be noted that the upper and lower boundaries 143, 145 may be offset from the edge of the display, as represented by the upper boundary in FIG. 1.

For another embodiment, the communication device 100 may have a hide mode and a show mode for the rich-text selectable toolbar 115. Based on user interaction at the user interface, such as selection of a button or menu item, the rich-text selectable toolbar 115 may be non-visible at the display 101 for the hide mode and visible at the display for the show mode. For the show mode, the rich-text selectable toolbar 115 behaves as described above. For the hide mode, the rich-text selectable toolbar 115 would not be visible and, thus, the rich-text attributes would not be selectable. For example, for the hide mode, the message header 111 and the message body 113 may be positioned adjacent to one another or the area formerly occupied by the toolbar may be replaced with a different toolbar, indicator, image, or the like.

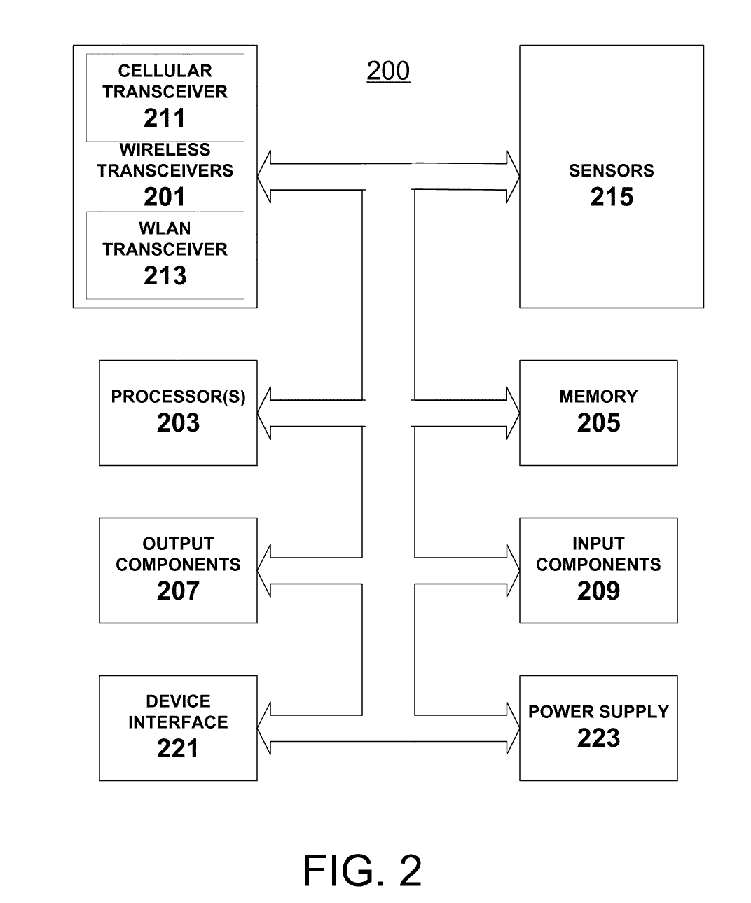

Referring to FIG. 2, there is shown a block diagram representing example components that may be used for an embodiment in accordance with the present invention. The example embodiment includes one or more wireless transceivers 201, one or more processors 203, one or more memories 205, one or more output components 207, and one or more input components 209. Each embodiment may include a user interface that comprises one or more input components 209. Each wireless transceiver 201 may utilize wireless technology for communication, such as, but are not limited to, cellular-based communications such as analog communications (using AMPS), digital communications (using CDMA, TDMA, GSM, iDEN, GPRS, or EDGE), and next generation communications (using UMTS, WCDMA, LTE, LTE-A or IEEE 802.16) and their variants, as represented by cellular transceiver 211. Each wireless transceiver 201 may also utilize wireless technology for communication, such as, but are not limited to, peer-to-peer or ad hoc communications such as HomeRF, Bluetooth and IEEE 802.11 (a, b, g or n); and other forms of wireless communication such as infrared technology, as represented by WLAN transceiver 213. Also, each transceiver 201 may be a receiver, a transmitter or both.

The processor 203 may generate commands based on information received from one or more input components 209 and one or more sensors 215. The processor 203 may process the received information alone or in combination with other data, such as the information stored in the memory 205. Thus, the memory 205 of the internal components 200 may be used by the processor 203 to store and retrieve data. The data that may be stored by the memory 205 include, but is not limited to, operating systems, applications, and data. Each operating system includes executable code that controls basic functions of the portable electronic device, such as interaction among the components of the internal components 200, communication with external devices via each transceiver 201 and/or the device interface (see below), and storage and retrieval of applications and data to and from the memory 205. Each application includes executable code which utilizes an operating system to provide more specific functionality for the portable electronic device. Data is non-executable code or information that may be referenced and/or manipulated by an operating system or application for performing functions of the portable electronic device.

The input components 209 of the internal components 200 may include a video input component such as an optical sensor (for example, a camera), an audio input component such as a microphone, and a mechanical input component such as button or key selection sensors, touch pad sensor, touch screen sensor, capacitive sensor, motion sensor, and switch. Likewise, the output components 207 of the internal components 200 may include a variety of video, audio and/or mechanical outputs. For example, the output components 207 may include a video output component such as a cathode ray tube, liquid crystal display, plasma display, incandescent light, fluorescent light, front or rear projection display, and light emitting diode indicator. Other examples of output components 207 include an audio output component such as a speaker, alarm and/or buzzer, and/or a mechanical output component such as vibrating or motion-based mechanisms.

The sensors 215 are similar to the input components 209, but may be separate as represented in FIG. 2. Examples of sensors 215 include, but are not limited to, accelerometers, touch sensors, surface/housing capacitive sensors, audio sensors, video sensors (such as a camera), and proximity sensors.

The internal components 200 may further include a device interface 221 to provide a direct connection to auxiliary components or accessories for additional or enhanced functionality. In addition, the internal components 200 preferably include a power source 223, such as a portable battery, for providing power to the other internal components and allow portability of the portable electronic device 101.

It is to be understood that FIG. 2 is provided for illustrative purposes only and for illustrating components of a portable electronic device in accordance with the present invention, and is not intended to be a complete schematic diagram of the various components required for a portable electronic device. Therefore, a portable electronic device may include various other components not shown in FIG. 2, or may include a combination of two or more components or a division of a particular component into two or more separate components, and still be within the scope of the present invention.

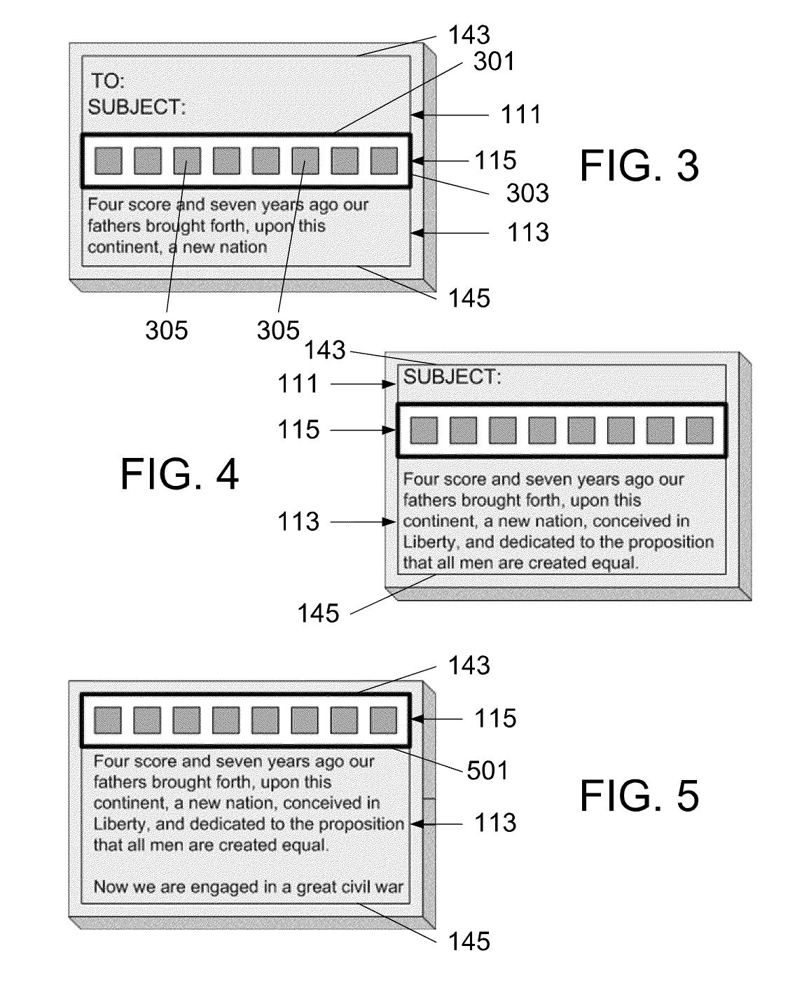

Referring to FIGS. 3 through 5, there are provided screen views illustrating example views that may be shown on the display 101 of the communication device 100. It is to be understood that FIGS. 3 through 5 may represent the entire viewable area of the display 101 or a portion thereof. For example, in reference to the embodiment shown in FIG. 1, FIGS. 3 through 5 represent the portion of display 101 below the messaging toolbar 135 and device toolbar 139; in other words, they represent the portion of the display 101 used by the message header 111, the rich-text selectable toolbar 115 and the message body 113.

Referring specifically to FIG. 3, there is shown a screen view of the message header 111, the rich-text selectable toolbar 115 and the message body 113 bounded by the upper boundary 143 above and the lower boundary 145 below. For this embodiment, the rich-text selectable toolbar 115 is positioned between the message header 111 and the message body 113, and the rich-text selectable toolbar is adjacent to both the message header and body. It is important to note that, for various embodiments, the rich-text selectable toolbar 115 may or may not be adjacent to the message header 111, but it is preferred to position the toolbar adjacent to the message body to facilitate a user's understanding that the attributes of the toolbar that are capable of being applied to the textual content of the message body. Also, for the view shown in FIG. 3, the rich-text selectable toolbar is non-adjacent to the upper boundary 143, because the message header 111 (or a portion thereof) is positioned between the toolbar and the upper boundary. Likewise, for this view, the rich-text selectable toolbar is non-adjacent to the lower boundary 145, because the message body 113 (or a portion thereof) is positioned between the toolbar and the lower boundary.

The rich-text selectable toolbar 115 is shown to be elongated horizontally such that the longer side 301 of the toolbar is parallel to the upper and lower boundaries 143, 145 and the shorter side 303 of the toolbar is perpendicular to the upper and lower boundaries. For this configuration, the message header 111, message body 113 and/or toolbar 115 may scroll vertically, i.e., upward or downward. In the alternative, it is possible to situate the toolbar so that it is elongated vertically. For this alternative embodiment, it may be more desirable to situate the boundaries to the left and right sides of the message header, message body and toolbar, and allow these regions to scroll horizontally, i.e., left or right. The rich-text selectable toolbar 115 includes a plurality of rich-text attributes 305 that are selectable via the user interface. By situating these selectable attributes 305 adjacent to the message body, these attributes are associated with the textual content of the message body, thus, minimizing possible confusion.

Referring to FIG. 4, there is shown a screen view similar to the view of FIG. 3, in which the portions of the message header 111, the rich-text selectable toolbar 115, and the message body 113 shown in FIG. 3 have scrolled upward toward the upper boundary 143 and away from the lower boundary 145. This operation may be performed in response to receiving a signal from the user interface indicating the user's desire to scroll the screen “downward”. It should be noted that a user's desire to scroll a screen downward translates into the content of the screen moving upward on the screen toward the upper boundary 143 and, likewise, a user's desire to scroll a screen upward translates into the content of the screen moving downward toward the lower boundary 145. Examples of signals that may indicate the user's desire to scroll downward includes selection or gesturing by the user at the user interface or entry of text to the message body 145. As the message header 111, the rich-text selectable toolbar 115, and the message body 113 scroll upward during this user intent to scroll the screen downward, the upper portion of the message header disappears from view as it reaches the upper boundary 143 and new space at the lower portion of the message body appears from the lower boundary 145.

Referring to FIG. 5, there is shown a screen view similar to FIG. 4, in which the message header 111 is no longer in view and the rich-text selectable toolbar 115 is positioned adjacent to the upper boundary 143. Again, the display 101 may transition from the view of FIG. 4 to the view of FIG. 5 by selection or gesturing by the user at the user interface or entry of text to the message body 145. At this point, if further signaling for scrolling the toolbar 115 and message body 113 is detected at the user interface, then the upper portion of the message body will disappear from view as it reaches the bottom side 501 of the toolbar, while the toolbar remains stationary and in full view in the display 101. In this manner, the rich-text selectable toolbar 115 always remains in view, i.e., persistent, and is positioned adjacent to the text area associated with the attributes.

FIGS. 3 through 5 represent scrolling of the message header 111, the rich-text selectable toolbar 115, and the message body 113 upward toward the upper boundary 143, but it is to be understood that a similar operation may be performed for scrolling these message elements and the toolbar downward toward the lower boundary 145.

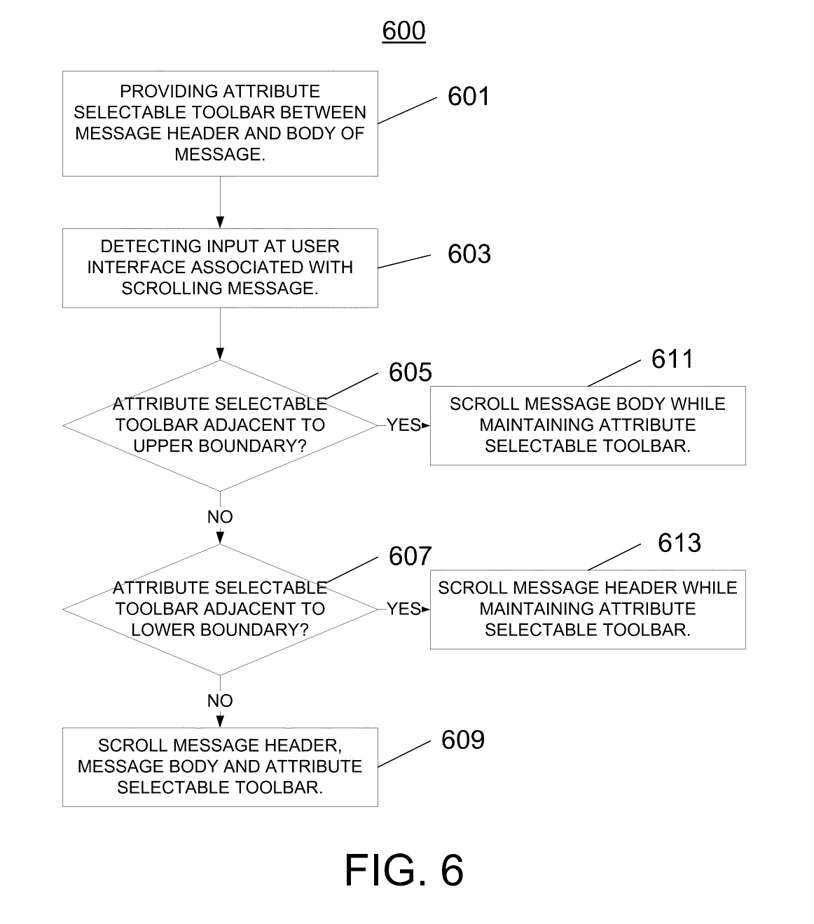

Referring FIG. 6, there is shown a flow diagram illustrating an example operation 600 of one or more embodiments described herein. Specifically, the example operation 600 represents a method of a communication device for communicating electronic messages as described below. A rich-text selectable toolbar is provided between a message header and a message body at step 601. The rich-text selectable toolbar provides a plurality of attributes that are capable of being applied to the textual content of the message body. The operation 600 then looks for any indication of a scrolling operation at step 603. For example, the operation may detect an input at the user interface associated with the message header and/or the message body to scroll relative to one or more boundaries of the display. Next, the operation determines whether the rich-text selectable toolbar is positioned adjacent to the upper or lower boundaries of the display at steps 605 and 607. If the rich-text selectable toolbar is not adjacent to either boundary, then the message header, the message body and the toolbar scroll in response to the input detected at the user interface at step 609. If, on the other hand, the rich-text selectable toolbar is adjacent to the upper boundary, then the message header is no longer in view and the message body scrolls while the toolbar remains in position adjacent to the upper boundary at step 611. Likewise, if the rich-text selectable toolbar is adjacent to the lower boundary, then the message body is no longer in view and the message header scrolls while the toolbar remains in position adjacent to the lower boundary.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A communication device for communicating electronic messages with a remote device comprising:
a transmitter for sending an electronic message to the remote device, the electronic message comprising a message header indicating a recipient's address, and a message body including textual content;
a user interface for generating input signals based on interaction with a user of the communication device;
a processor coupled to the transceiver and user interface, the processor creating the electronic message based on the input signals for a messaging mode of the device and providing the electronic message to the transmitter; and
a display coupled to the processor, the display providing an attribute selectable toolbar positioned between the message header and the message body, the attribute selectable toolbar providing a plurality of attributes that are capable of being applied to the textual content of the message body.

2. The communication device of claim 1, wherein the plurality of attributes comprises a plurality of rich-text attributes including at least one of font name, font size, font style, font color, or font effects.

3. The communication device of claim 1, wherein the attribute selectable toolbar is adjacent to the textual content of the message body.

4. The communication device of claim 1, wherein the display has boundaries within which content is provided and the attribute selectable toolbar, in its entirety, is always provided within the boundaries in the messaging mode regardless of the position of the message header and the message body.

5. The communication device of claim 1, wherein the attribute selectable toolbar is a linear toolbar in which each attribute of the plurality of attributes is selectable by the user interface.

6. The communication device of claim 1, wherein:
the display includes an upper boundary and a lower boundary opposite the upper boundary; and
the attribute selectable toolbar is a linear toolbar parallel to the upper and lower boundaries.

7. The communication device of claim 6, wherein the attribute selectable toolbar may not be positioned beyond the upper boundary or the lower boundary in the messaging mode.

8. The communication device of claim 6, wherein:
content of the message header and the message body shown by the display may scroll upward toward the upper boundary or downward toward the lower boundary;
content of the message header and the message body scrolling past the upper boundary or the lower boundary is no longer shown by the display; and
content of the attribute selectable toolbar may not scroll past the upper boundary or lower boundary of the display.

9. The communication device of claim 6, wherein at least one of the upper boundary or the lower boundary of the display is offset from an edge of the display.

10. A method of a communication device for communicating electronic messages, the communication device including a user interface and a display having a boundary, the method comprising:
providing a message header indicating a recipient's address, a message body including textual content, and an attribute selectable toolbar between the message header and the message body providing a plurality of attributes that are capable of being applied to the textual content of the message body;
detecting input at the user interface associated with at least one of the message header or the message body to scroll relative to the boundary of the display;
determining whether the attribute selectable toolbar is positioned adjacent to the boundary of the display;
scrolling at least one of the message header or the message body relative to the boundary and maintaining the attribute selectable toolbar adjacent to the boundary of the display in response to detecting the input at the user interface and determining that the attribute selectable toolbar is positioned adjacent to the boundary; and
scrolling at least one of the message header or the message body relative to the boundary and scrolling the attribute selectable toolbar relative to the boundary in response to detecting the input at the user interface and determining that the attribute selectable toolbar is positioned non-adjacent to the boundary.

11. The method of claim 10, wherein:
detecting input at the user interface includes detecting the input at the user interface associated with at least one of the message header or the message body to scroll toward the boundary of the display;
scrolling at least one of the message header or the message body relative to the boundary and maintaining the attribute selectable toolbar adjacent to the boundary of the display includes scrolling at least one of the message header or the message body toward the boundary and maintaining the attribute selectable toolbar adjacent to the boundary of the display; and
scrolling at least one of the message header or the message body relative to the boundary and scrolling the attribute selectable toolbar relative to the boundary of the display includes scrolling at least one of the message header or the message body toward the boundary and scrolling the attribute selectable toolbar toward the boundary.

12. The method of claim 10, wherein:
determining whether the attribute selectable toolbar is positioned adjacent to the boundary of the display includes determining whether the attribute selectable toolbar is adjacent to a upper boundary of the display and a lower boundary of the display opposite the upper boundary; and
scrolling at least one of the message header or the message body relative to the boundary and scrolling the attribute selectable toolbar relative to the boundary of the display includes scrolling the attribute selectable toolbar along with the message header and the message body in response to determining that the attribute selectable toolbar is positioned non-adjacent to the upper and lower boundaries of the display.

13. The method of claim 10, wherein:
determining whether the attribute selectable toolbar is positioned adjacent to the boundary of the display includes determining whether the attribute selectable toolbar is adjacent to a upper boundary of the display and a lower boundary of the display opposite the upper boundary; and
scrolling at least one of the message header or the message body relative to the boundary and maintaining the attribute selectable toolbar adjacent to the boundary of the display includes scrolling the message body toward the attribute selectable toolbar when the attribute selectable toolbar is maintained adjacent to the boundary of the display and the message header is no longer visible at the display.

14. The method of claim 10, wherein:
determining whether the attribute selectable toolbar is positioned adjacent to the boundary of the display includes determining whether the attribute selectable toolbar is adjacent to a upper boundary of the display and a lower boundary of the display opposite the upper boundary; and
scrolling at least one of the message header or the message body relative to the boundary and maintaining the attribute selectable toolbar adjacent to the boundary of the display includes scrolling the message header toward the attribute selectable toolbar when the attribute selectable toolbar is maintained adjacent to the boundary of the display and the message body is no longer visible at the display.

15. A communication device for communicating electronic messages with a remote device comprising:
a transmitter for sending an electronic message to the remote device, the electronic message comprising a message header indicating a recipient's address, and a message body including textual content;
a user interface for generating input signals based on interaction with a user of the communication device;
a processor coupled to the transceiver and user interface, the processor creating the electronic message based on the input signals for a messaging mode of the device and providing the electronic message to the transmitter; and
a display coupled to the processor, the attribute selectable toolbar providing a plurality attributes that capable of being applied to the textual content of the message body, the plurality of attributes including an attribute indicator,
wherein each attribute of the plurality of attributes is capable of being selected via the user interface, and all attributes selected by the user interface are represented by the attribute indicator.

16. The communication device of claim 15, wherein the plurality of attributes comprises a plurality of rich-text attributes including at least one of font name, font size, font style, font color, or font effects.
